(19) United States
(12) Patent Application Publication
(10) Pub. No.: US 2006/0283886 A1
(43) Pub. Date: Dec. 21, 2006

(54) Equalizing device for a multicomponent discharging device

(75) Inventor: Wilhelm A. Keller, Merlischachen (CH)

Correspondence Address: FOLEY AND LARDNER LLP;SUITE 500, 3000 K STREET NW, WASHINGTON, DC, 20007, US

(73) Assignee: Mixpac Systems AG

(21) Appl. No.: 10/556,075

(22) PCT Filed: May 14, 2004
(86) PCT No.: PCT/CH04/00296

§ 371 Date: Nov. 9, 2005

(30) Foreign Application Priority Data
May 15, 2003 (CH) 2003 0860/03

(51) Int. Cl. B67D 5/52

(52) U.S. Cl. 222/137

(57) ABSTRACT

The compensating device for a two-component cartridge (1) comprises means (16, 17) for its detachable connection to the cartridge, separate inlets (16, 17) whose number corresponds to the number of components (5, 6), and at least one chamber (14, 15) having at least one outlet (21), the outlet (21) being closed in such a manner that it is essentially impermeable to the components but permeable to air. A detachable compensating device of this kind allows a complete evacuation of storage containers of multicomponent dispensing devices and an alignment of the pistons (7, 8) of the dispensing device at the same level to ensure that all components reach the mixer simultaneously at the beginning of the dispensing operation.

The present invention refers to a compensating device for a multicomponent dispensing device that may be in the form of a multicomponent cartridge or syringe or a multicomponent dispensing appliance.

In some applications, particularly in the field of medicine, it is necessary to completely evacuate the storage cylinders prior to dispensing and mixing as well as possibly remaining air or gas that has been formed during gamma sterilization and to align the component levels so that the correct mixing ratio of the components can be ensured from the very beginning of the dispensing or mixing operation, respectively.

U.S. Pat. No. 5,413,253 discloses a closure cap comprising a pair of closure plugs and a pair of open passages arranged at 90°. Prior to filling, the closure cap is attached to the outlets of the cartridge with the plugs closed and is subsequently filled. Before use, the cap is withdrawn, turned by 90°, and replaced. Then material is dispensed until it flows from both outlets into a reservoir in the cap, thereby indicating that the levels are aligned and that the mixer can be attached. Although this anteriority allows a good alignment of the cartridge filling levels for a very particular combination of a cartridge, closure cap, and mixer in the case of small filling level differences, the combination of the closure cap and the aligning means requires a specific construction, and a complete air evacuation is not disclosed. Moreover, this arrangement is only suitable for relatively viscous compositions.

On the background of this prior art, it is the object of the present invention to provide a simple and universally applicable device allowing an alignment of the piston levels and the evacuation of existing residual air prior to the dispensing operation as well as a safe storage and disposal of waste material, particularly in the case of relatively fluid materials, in order to ensure that when the mixer is attached, the materials reach the mixer simultaneously and in an air-free condition and are mixed in the correct ratio. This is accomplished by the device as described in claim 1.

The invention will be explained in more detail hereinafter with reference to drawings of exemplary embodiments.

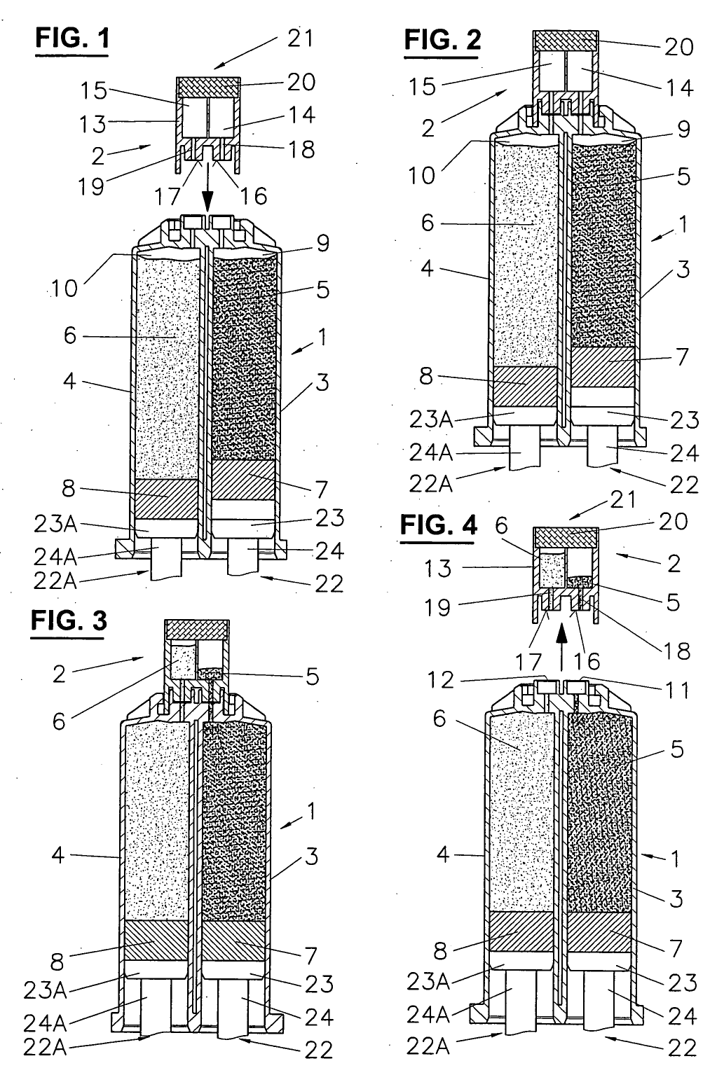

FIG. 1 shows a two-component cartridge to which a compensating device of the invention is attached;

FIGS. 2, 3 show two successive stages of the aligning process;

FIG. 4 shows the cartridge with the pistons aligned and the device of the invention withdrawn;

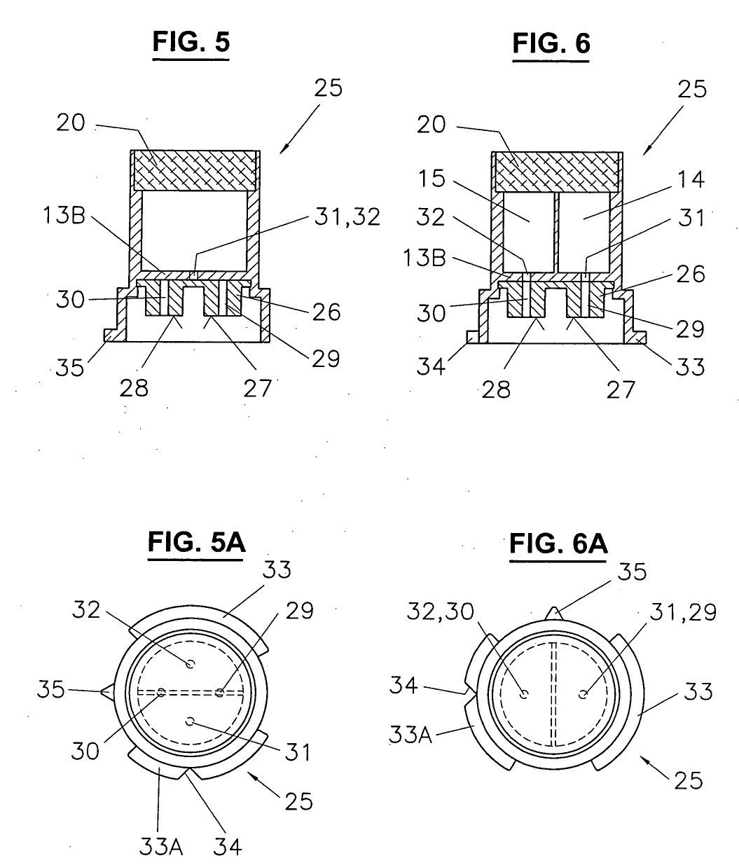

FIGS. 5, 5A show an alternative embodiment of compensating device in the closed position; and

FIGS. 6, 6A show the alternative embodiment of FIGS. 5, 5A in the open position.

A known two-component cartridge 1 and the compensating device 2 of the invention are illustrated in FIG. 1. Cartridge 1 comprises two cylindrical storage containers 3 and 4 that have been filled with different materials 5 and 6 and are obturated by pistons 7 and 8 which are only schematically illustrated here and are located at different levels. The pistons are actuated by thrust rods 22, 22A of a dispensing appliance that are each provided with a respective thrust plate 23, 23A secured to a respective shaft 24, 24A. The two thrust plates are always at the same height, i.e. in FIGS. 1 and 2, thrust plate 23A is located at the height of piston 8 and thrust plate 23 is located at the same height, however at a distance from piston 7. The cartridge comprises an outlet of a type known in the art with two separate outlets 11 and 12.

Compensating device 2 consists of an enclosure 13 in which two chambers 14 and 15 are arranged which are connectable, by respective inlets 16 and 17 having respective bores 18 and 19, to outlets 11 and 12 of the cartridge. In this example, a portion of the enclosure wall extends beyond the stems to provide support on the cartridge. In this example, at the end opposite the inlets, outlet 21 of the enclosure is closed by a fine pored filter 20. The fine pored filter may e.g. consist of a material that expands when moistened and thereby acts as a closure so that essentially no material can escape particularly in the case of fluid materials.

Another effect is that overflowing material is safely stored in the compensating device for subsequent disposal.

The compensating device need not have a respective chamber and corresponding outlets for each inlet. An important requirement are separate inlets whose length must be sufficient to exclude that the components may mix and harden at the cartridge outlet. However, if the components are not or only hardly distinguishable optically, a respective chamber for each component is advantageous for determining whether both components have reached the respective chamber to ensure a complete evacuation of both cartridge cylinders.

Instead of a fine pored filter on the outlet side of the enclosure, a cap having a capillary opening or a plurality of capillary openings may be used from which essentially only air but no material may escape. The number and arrangement of the outlets may vary. Thus, for example, there may be a respective outlet for each chamber, or the chamber outlets may lead to a common outlet in the enclosure. The individual enclosure outlets may also be provided each with a fine pored filter or with one or a plurality of capillary opening(s).

After the attachment of the compensating device, generally in the vertical position of the cartridge as illustrated in FIG. 1, possible air bubbles 9 and 10 contained in the cartridge may escape towards the outlets and the compensating device. In FIG. 3, the two pistons have been thrust in by thrust rods 22 until possibly remaining air has completely escaped and the two components have reached the compensating device resp. chambers 14 and 15 and the pistons are aligned. Thus, the two pistons are at the same level such that in the subsequent dispensing operation, both components reach the mixer simultaneously, thereby ensuring that the accurate mixing ratio is accomplished.

Generally, the entrance of the materials into the chambers will be visualized, e.g. by manufacturing the entire compensating device or only the chambers or parts thereof from a transparent material.

FIG. 4 shows the compensating device that has been withdrawn from the completely evacuated cartridge with both pistons positioned at the same level. Depending on the intended application, either a mixer or an accessory such as a transfer portion or an extension may be connected to the cartridge, or else the closure plug may be replaced on the cartridge.

An alternative embodiment having a closure of the inlets is illustrated in FIGS. 5, 5A, 6, 6A. Compensating device 25 includes the same enclosure, the same chambers, outlets, and filters as the device according to FIGS. 1 to 4. In contrast to the latter embodiment, inlet portion 26 with the two inlets 27 and 28 with respective bores 29 and 30 is rotatable in the lower section of enclosure 13, and the bottom 13B of the enclosure, which separates the chambers from the inlet section, comprises two passages 31 and 32, see FIG. 6.

In this alternative embodiment, enclosure 13 comprises two bayonet flanges 33, 33A cooperating with corresponding bayonet sockets on the cartridge. Inlets 27, 28 are disposed in such a relationship to the bayonet lugs that their bores 29, 30 communicate with passages 31, 32 in the enclosure bottom after having been attached and subsequently locked. After the alignment and evacuation of the cartridge, the compensating device is unlocked by rotation thereof, thereby closing the passages such that no material may escape from the compensating device.

The compensating device is not limited to a two-component cartridge and may be used for any type of dispensing device where a complete evacuation and the alignment of the pistons at the same level is required. In particular, the compensating device may also be secured to a transfer portion between the cartridge resp. the dispensing appliance and the mixer to ensure that this portion is evacuated and completely filled as well.

The drawings and the preceding description are based on a cartridge and compensating device having side-by-side outlets/inlets. However, the compensating device of the invention is also suitable for cartridges and/or compensation devices where the two components are disposed concentrically. In this case, a different temporary closure must be provided.

A closure having a rotatable inlet portion according to FIGS. 5 and 6 may also be used as a temporary closure for another accessory, e.g. for a transfer portion, if an outflow of material is to be prevented, the accessory comprising, between the inlet portion provided with separate inlets and the remainder of the accessory, a bottom wall having passages that either communicate with the bores of the inlets or are closed through rotation of the accessory.

In all embodiments of the compensating device and of the closure, the enclosure may comprise bayonet coupling members cooperating, through a coded arrangement known per se, with another bayonet coupling member of the dispensing appliance in such a manner that the attachment of the accessory to the dispensing appliance is only possible in a certain orientation. To this end, one of bayonet flanges 33 may be longer than the other flange 33A and/or the other bayonet flange 33A may be provided with an incision 34, and/or a nose 35 may be disposed between the flanges to facilitate the attachment in one direction.

However, the connection between the compensating device and the cartridge may also be established by means of different kinds of snap closures that are known in the art per se and where a bead or the like on one portion engages behind a collar or a bead on the other portion.

1. A compensating device for a multicomponent dispensing device, comprising an enclosure having means for its detachable connection to the multicomponent dispensing device and separate inlets whose number corresponds to the number of components and which lead to at least one chamber, wherein the enclosure comprises at least one outlet and the outlet or outlets of the enclosure is/are essentially impermeable to the components but permeable to air.

2. A compensating device according to claim 1 for a multicomponent dispensing device having side-by-side outlets, wherein the side-by-side inlets are arranged in an inlet portion that is rotatable with respect to the enclosure, and in that between the chambers and the inlet portion, an enclosure bottom wall is disposed which is provided with passages such that the passages are closed in one position of the compensating device and connected to the bores of the inlets in another position.

3. A compensating device according to claim 1, wherein the enclosure comprises bayonet flanges cooperating with bayonet sockets on the dispensing device.

4. A compensating device according to claim 1, wherein a separate chamber is associated to each inlet.

5. A compensating device according to claim 1, wherein the enclosure comprises an outlet for each chamber.

6. A compensating device according to claim 1, wherein the outlet or the outlets is/are provided with a respective fine pored filter.

7. A compensating device according to claim 1, wherein the outlet or the outlets is/are provided with a respective capillary opening or a plurality thereof.

8. A compensating device according to claim 1, wherein the components are arranged in the dispensing device and/or in the compensating device in a concentric disposition and separated from each other.

9. A device for the temporary closure of an accessory that is connectable to a dispensing appliance, comprising an enclosure and separate inlets, wherein the separate inlets are arranged in an inlet portion that is rotatable with respect to the enclosure of the accessory, and in that between the inlet portion and the remainder of the accessory, an enclosure bottom wall having passages is disposed and the passages are closed in one position of the accessory and connected to the bores of the inlets in another, rotated position.

10. A device according to claim 9, wherein the enclosure comprises bayonet closure flanges or a snap closure.

11. A device according to claim 9, wherein the bayonet closure flanges and/or the enclosure comprise coding means allowing a directed attachment to the dispensing device or the accessory.
